(19) United States
(12) Patent Application Publication
(10) Pub. No.: US 2011/0278864 A1
(43) Pub. Date: Nov. 17, 2011

(54) CLIP ASSEMBLY FOR VEHICLE DOOR LATCH ROD

(75) Inventors: Jeffrey L. Konchan, Romeo, MI (US); Frank J. Arabia, JR., Macomb, MI (US); Lisa J. Dodson, Ortonville, MI (US)

(73) Assignee: GM GLOBAL TECHNOLOGY OPERATIONS, INC., Detroit, MI (US)

(21) Appl. No.: 12/778,201

(22) Filed: May 12, 2010

(51) Int. Cl. E05C 3/16; F16L 3/16

(52) U.S. Cl. 292/223; 74/502.4

(57) ABSTRACT

A clip assembly for securing a latch rod includes a main body and a pivoting body rotatably coupled to the main body. The pivoting body is moveable between an open position allowing insertion of the latch rod relative to the clip assembly, and a closed position securing the latch rod relative to the clip assembly. A fastening mechanism is moveable between a fastened position securing the pivoting body relative to the main body and an un-fastened position allowing the rotational movement of the pivoting body relative to the main body. A biasing device is coupled to the main body and biases the pivoting body into the open position when the fastening mechanism is in the un-fastened position to visually and/or functionally indicate that the pivoting body is not fastened to the main body, and the latch rod is not properly secured within the clip assembly.

### TECHNICAL FIELD

The invention generally relates to a clip assembly for securing a latch rod relative to a latch mechanism of a vehicle door panel, and a method of attaching the latch rod to the latch mechanism of the vehicle door panel with the clip assembly.

### BACKGROUND

Vehicle doors include a handle to operate a door latch mechanism. Each door includes an outside handle for actuating the latch mechanism from outside the vehicle, and an inside handle for actuating the latch mechanism from inside the vehicle. Typically, the inside handle is directly connected to the latch mechanism, and the outside handle is remotely connected to latch mechanism by a latch rod. The latch rod extends between and interconnects the outside handle and the latch mechanism, and transmits movement from the outside handle to the latch mechanism to actuate the latch mechanism.

A clip assembly interconnects the latch rod and the latch mechanism. The clip assembly is mounted to the latch mechanism and secures the latch rod in place relative to the latch mechanism. The clip assembly may include a main body and a pivoting body. The pivoting body rotates about a pivot axis between an open position and a closed position. When in the open position, the latch rod is free to move relative to the clip assembly. When in the closed position, the pivoting body engages the latch rod to secure the latch rod relative to the clip assembly. A fastening mechanism, such as a detent latch, may fasten the pivoting body relative to the main body when in the closed position.

During assembly, the latch rod is positioned relative to the clip assembly along an alignment axis, and the pivoting body is rotated into the closed position to fasten the latch rod relative to the latch mechanism. If the fastening mechanism is not properly fastened, then the latch rod may become dislodged or misaligned relative to the latch mechanism over a period of time. Additionally, if the latch rod is not properly positioned along the alignment axis during assembly, the latch rod may prevent proper closure of the pivoting body, and thereby prevent proper fastening of the pivoting body relative to the main body.

### SUMMARY

A clip assembly for securing a latch rod relative to a latch mechanism of a vehicle door panel is provided. The clip assembly includes a main body. The main body includes an alignment feature that is configured for aligning the latch rod along an alignment axis relative to the main body. The clip assembly further includes a pivoting body. The pivoting body is rotatably coupled to the main body for rotational movement about a pivot axis. The pivoting body is moveable between an open position for allowing insertion of the latch rod into the alignment feature and a closed position for securing the latch rod relative to the main body. The clip assembly further includes a fastening mechanism. The fastening mechanism is moveable between a fastened position, securing the pivoting body in the closed position, and an un-fastened position, allowing the rotational movement of the pivoting body. The clip assembly further includes a biasing device. The biasing device is coupled to the main body, and is configured for biasing the pivoting body into the open position when the fastening mechanism is in the un-fastened position.

A door assembly for a vehicle is also provided. The door assembly includes a door panel supporting a door handle, and a latch mechanism. A latch rod interconnects the door handle and the locking mechanism. The latch rod is configured for transferring motion from the door handle to the latch mechanism. The door assembly further includes a clip assembly. The clip assembly interconnects the latch rod and the latch mechanism. The clip assembly includes a main body attached to the latch mechanism. The main body includes an alignment feature for aligning the latch rod along an alignment axis relative to the main body. The alignment feature includes a first pocket and a second pocket. The second pocket is axially spaced from the first pocket along the longitudinal axis. The first pocket and the second pocket each include a cross section defining a semi-circular shape presenting an open face perpendicular to the alignment axis for receiving the latch rod. The clip assembly further includes a pivoting body. The pivoting body is rotatably coupled to the main body for rotational movement about a pivot axis. The pivot axis is parallel with and laterally offset from the alignment axis. The pivoting body is moveable between an open position, for allowing insertion of the latch rod into the alignment feature, and a closed position, for securing the latch rod relative to the alignment feature. The clip assembly further includes a fastening mechanism. The fastening mechanism is moveable between a fastened position, securing the pivoting body in the closed position, and an un-fastened position, allowing the rotational movement of the pivoting body. The clip assembly further includes a biasing device. The biasing device is coupled to the main body, and is configured for biasing the pivoting body into the open position when the fastening mechanism is in the un-fastened position. Biasing the pivoting body into the open position when the fastening mechanism is in the un-fastened position provides a visual and functional indication that the fastening mechanism is not in the fastened position.

A method of attaching a latch rod to a latch mechanism of a vehicle door panel with a clip assembly is also provided. The method includes inserting the latch rod into an alignment feature of the clip assembly to position the latch rod relative to a main body of the clip assembly along an alignment axis. The method further includes rotating a pivoting body of the clip assembly relative to the main body about a pivot axis into engagement with a biasing device. The biasing device provides a biasing force to resist rotation of the pivoting body and to rotate the pivoting body against the biasing force into a closed position securing the latch rod relative to the main body. The method further includes engaging a fastening mechanism to fasten the pivoting body relative to the main body and secure the latch rod relative to the clip assembly. The method further includes inspecting the clip assembly to ascertain the position of the pivoting body to determine successful fastening of the pivoting body relative to the main body. The pivoting body is disposed in the closed position when the pivoting body is successfully fastened relative to the main body. The biasing force from the biasing device urges the pivoting body into an open position allowing movement of the latch rod relative to the main body to indicate an un-successful fastening of the pivoting body relative to the main body.

Accordingly, the biasing device provides a biasing force, which resists closure of the pivoting body relative to the main body. If the pivoting body is not properly fastened relative to the main body, the biasing device biases the pivoting body back into the open position, thereby visually and functionally indicating that the latch rod is not secured within the clip assembly, and preventing an assembler from confusing a nearly closed pivoting body from a completely closed pivoting body.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side plan view of a door panel of a vehicle.

FIG. 2 is a schematic perspective view of a clip assembly of the door panel in an open position.

FIG. 3 is a schematic side plan view of the clip assembly in the open position.

FIG. 4 is a schematic side plan view of the clip assembly in a closed position.

### DETAILED DESCRIPTION

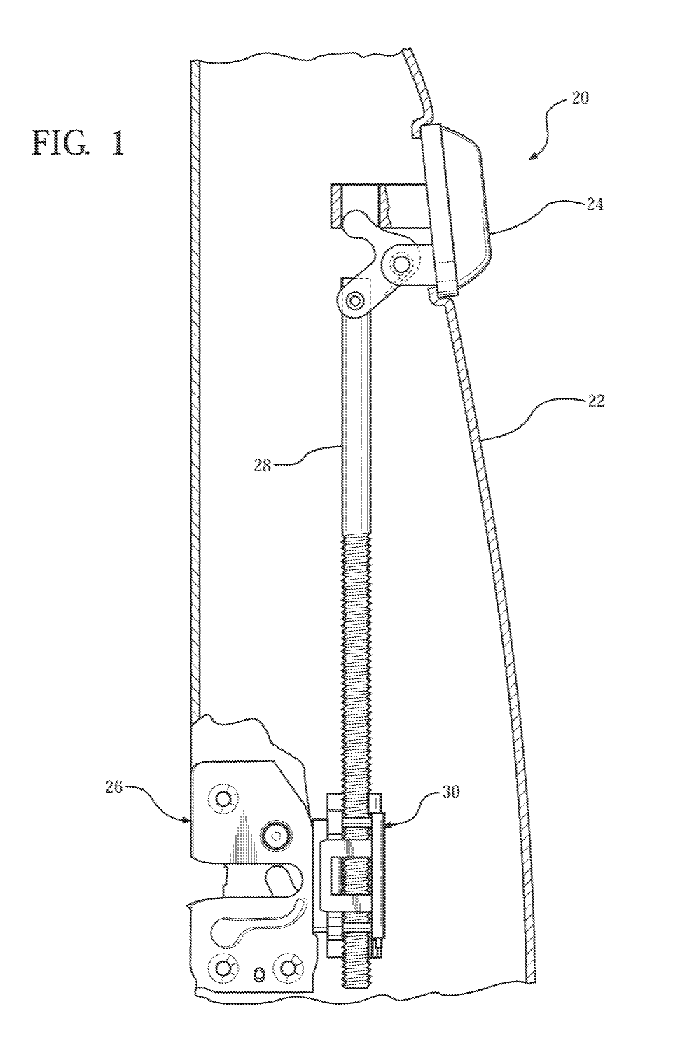

Referring to the Figures, wherein like numerals indicate like parts throughout the several views, a door assembly is shown generally at 20. Referring to FIG. 1, the door assembly 20 is for a vehicle, and includes a door panel 22 supporting a door handle 24.

The door handle 24 is disposed on the exterior of the door assembly 20 to open and close the door from outside the vehicle. The door handle 24 may include any type, style and/or configuration suitable for use in vehicle door assemblies. Accordingly, the specific design and operation of the door handle 24 is not described in detail herein.

The door handle 24 is coupled to and actuates a latch mechanism 26. The latch mechanism 26 engages a structural element of the vehicle to latch the door in a closed position. The latch mechanism 26 may include any suitable type, style and/or configuration suitable for use in vehicle door assemblies. Accordingly, the specific design and operation of the latch mechanism 26 is not described in detail herein.

A latch rod 28 interconnects the door handle 24 and the locking mechanism. The latch rod 28 is configured for transferring motion from the door handle 24 to the latch mechanism 26. As such, movement of the door handle 24 is transferred to the latch rod 28, which in turn transfers movement to the latch mechanism 26 to actuate the latch mechanism 26. The latch rod 28 may include any shape and/or length suitable for the specific design constraints. The latch rod 28 includes a griping feature disposed at an end of the latch rod 28, adjacent latch mechanism 26. The griping feature may include any suitable geometric or surface irregularity, such as but not limited to, a plurality of annular ridges disposed concentrically about the latch rod 28 along a length of the latch rod 28.

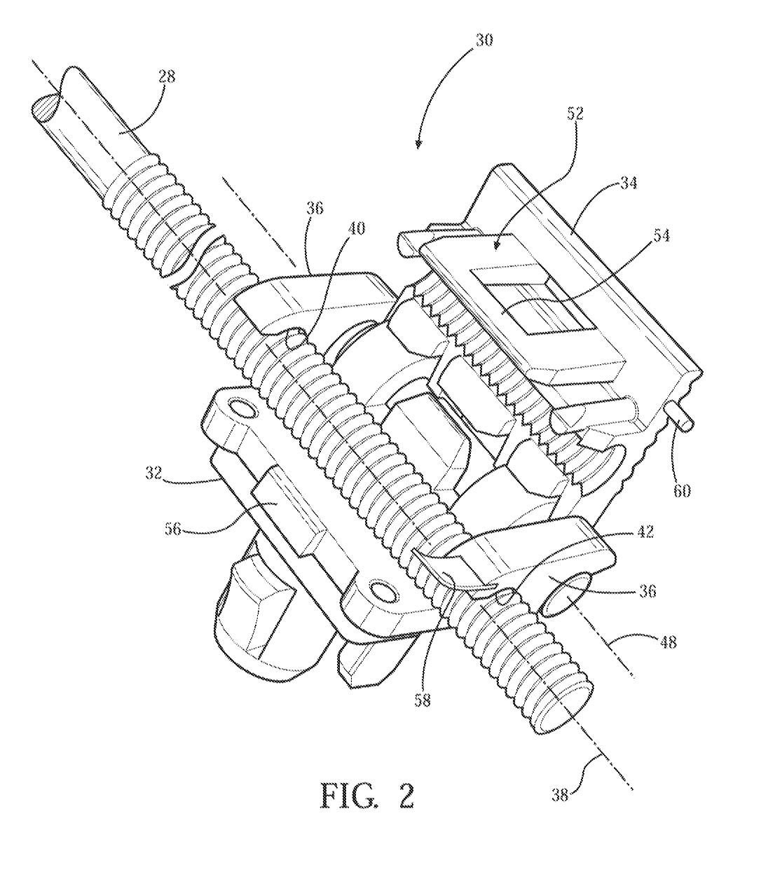

The door assembly 20 further includes a clip assembly 30. The clip assembly 30 interconnects the latch rod 28 and the latch mechanism 26. More specifically, the clip assembly 30 is mounted to the latch mechanism 26, and secures the latch rod 28 thereto. Referring also to FIG. 2, the clip assembly 30 includes a main body 32 and a pivoting body 34. The main body 32 is securely attached to the latch mechanism 26, such as through a snap fit connection, a fastener, or some other similar manner attachment.

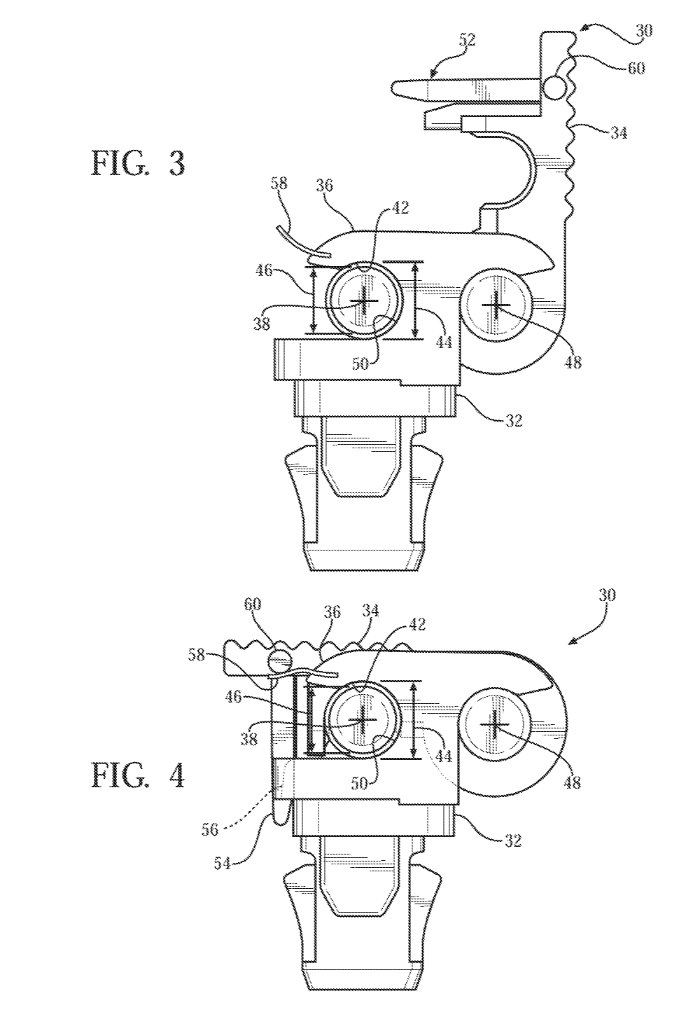

The main body 32 includes an alignment feature 36, which is configured for aligning the latch rod 28 along an alignment axis 38 relative to the main body 32. As best shown in FIG. 3, the alignment feature 36 includes at least one pocket having a cross section defining a semi-circular shape presenting an open face perpendicular to the alignment axis 38. More specifically, the at least one pocket includes a first pocket 40 and a second pocket 42 axially spaced from the first pocket 40 along the alignment axis 38. The circular cross sectional shape of each of the first pocket 40 and the second pocket 42 define an inner diameter 44 that is greater than an outer diameter 46 of the latch rod 28. The inner diameter 44 of the first pocket 40 and the second pocket 42 is larger than the outside diameter of the latch rod 28 to permit axial movement of the latch rod 28 along the alignment axis 38 during assembly of the door panel 22.

The pivoting body 34 is rotatably coupled to the main body 32 for rotational movement about a pivot axis 48. The alignment axis 38 is parallel with and laterally spaced from the pivot axis 48. The pivoting body 34 is moveable between an open position, shown in FIG. 3, and a closed position, shown in FIG. 4. When the pivoting body 34 is in the open position, the pivoting body 34 allows for insertion of the latch rod 28 into the alignment feature 36 and positioning of the latch rod 28 relative to the clip assembly 30 during assembly of the door panel 22. When the pivoting body 34 is in the closed position, the pivoting body 34 secures the latch rod 28 relative to the main body 32 to transfer motion between the door handle 24 and the latch mechanism 26. Accordingly, the pivoting body 34 is moved from the open position to the closed position during assembly, and remains in the closed position during operation of the vehicle. Failure to properly secure the pivoting body 34 completely in the closed position may permit undesirable movement of the latch rod 28 during operation of the vehicle, thereby interrupting proper operation of the door assembly 20.

The pivoting body 34 defines an annular channel 50 extending along the alignment axis 38 that is concentric with the first pocket 40 and the second pocket 42 when the pivoting body 34 is in the closed position. The annular channel 50 includes griping features corresponding to the griping features of the latch rod 28. Accordingly, when the pivoting body 34 is in the closed position, the gripping features of the annular channel 50 engage the griping features on the latch rod 28 in mechanical interlocking engagement to secure the latch rod 28 relative to the clip assembly 30. If the pivoting body 34 is not completely closed, the griping features on the annular channel 50 do not properly engage the griping features on the latch rod 28, and the latch rod 28 may become disengaged from the pivoting body 34.

The clip assembly 30 further includes a fastening mechanism 52. The fastening mechanism 52 is moveable between a fastened position and an un-fastened position. When in the fastened position, the fastening mechanism 52 secures the pivoting body 34 in the closed position. When in the un-fastened position, the fastening mechanism 52 allows the rotational movement of the pivoting body 34, and the pivoting body 34 is not secured in the closed position. Additionally, when the fastening mechanism 52 is in the un-fastened position, axial movement of the latch rod 28 along the alignment axis 38 may occur. Accordingly, during assembly of the door assembly 20, failure to completely engage the fastening mechanism 52 in the fastened position may allow the pivoting body 34 to rotate back to the open position, thereby releasing engagement with the latch rod 28 and permitting undesirable movement of the latch rod 28.

As shown, the fastening mechanism 52 includes a snap 54. The snap 54 extends from the pivoting body 34. The snap 54 is configured for engaging a detent 56 on the main body 32 in interlocking engagement when in the fastened position. Accordingly, the snap 54 moves into interlocking engagement with the detent 56 when the pivoting body 34 is completely moved into the closed position. It should be appreciated that the fastening mechanism 52 may include some other type of mechanism not shown or described herein that is capable of securing the pivoting body 34 in the closed position relative to the main body 32.

Referring to FIGS. 2 through 4, the clip assembly 30 further includes a biasing device 58. The biasing device 58 is coupled to the main body 32, and is configured for biasing the pivoting body 34 into the open position when the fastening mechanism 52 is in the un-fastened position. As such, during assembly of the door assembly 20, the pivoting body 34 is rotated against and must overcome a biasing force provided by the biasing device 58. If the pivoting body 34 is not completely moved into the closed position and/or the fastening mechanism 52 is not moved into the fastened position, the biasing force from the biasing device 58 moves the pivoting body 34 back into the open position. Accordingly, the biasing device 58 ensures that the pivoting body 34 does not remain in a nearly closed position with the fastening mechanism 52 not in the fastened position. As such, if the fastening mechanism 52 fails to properly operate and/or move into the fastened position, the biasing device 58 moves the pivoting body 34 back into the open position so that an inspector may easily see through visual inspection or learn through a functional test that the pivoting body 34 is not in the closed position.

Preferably, the biasing device 58 includes a spring. However, it should be appreciated that the biasing device 58 may include some other type of device capable of moving the pivoting body 34 into the open position when the fastening mechanism 52 is in the un-fastened position. More specifically, the biasing device 58 may include a cantilevered leaf spring extending outward from the main body 32 in a perpendicular relationship relative to the pivot axis 48. The cantilevered leaf spring is configured for engaging the pivoting body 34 during rotation of the pivoting body 34 from the open position into the closed position. As shown, the pivoting body 34 includes a peg 60. The peg 60 extends outward from the pivoting body 34 in parallel relationship relative to the pivot axis 48. The peg 60 is configured for engaging the cantilevered leaf spring during the rotational movement of the pivoting body 34 relative to the main body 32. It should be appreciated that the pivoting body 34 may be shaped and/or configured in some other manner than that shown to engage the biasing device 58.

In another aspect of the invention, a method of attaching the latch rod 28 to the latch mechanism 26 of the vehicle door panel 22 with the clip assembly 30 is provided. The method includes inserting the latch rod 28 into the alignment feature 36 of the main body 32 to position the latch rod 28 relative to the main body 32 along an alignment axis 38. The latch rod 28 may be slid down along the alignment axis 38, through the first pocket 40 and the second pocket 42. Alternatively, the latch rod 28 may be inserted into the first pocket 40 and the second pocket 42 laterally through the open face of the first pocket 40 and the second pocket 42 respectively until concentric with the alignment axis 38.

The method may further include sizing the semi-circular cross sectional shape of the at least one pocket to define the inner diameter 44 of the first pocket 40 and the second pocket 42 respectively to be greater than the outer diameter 46 of the latch rod 28. The inner diameter 44 of the first pocket 40 and the second pocket 42 is sized to be larger than the outer diameter 46 of the latch rod 28 to ensure the latch rod 28 moves freely along the alignment axis 38 within the alignment feature 36, i.e., the first pocket 40 and the second pocket 42, prior to being secured in place by the pivoting body 34 and engaging the fastening mechanism 52.

The method may further include positioning the latch rod 28 axially along the alignment axis 38 relative to the clip assembly 30 prior to engaging the fastening mechanism 52. The latch rod 28 is positioned along the alignment axis 38 so as to provide the proper motion transfer between the door handle 24 and the latch mechanism 26. The latch rod 28 may be positioned at any location suitable for the specific use.

The method further includes rotating the pivoting body 34 about the pivot axis 48 into engagement with the biasing device 58, such that the biasing device 58 provides a biasing force resisting rotation of the pivoting body 34. The method may further include flexing the leaf spring with the peg 60 during the rotation of the pivoting body 34 relative to the main body 32 to generate the biasing force for resisting the rotational movement of the pivoting body 34. The method further includes rotating the pivoting body 34 against the biasing force into the closed position;

The method further includes engaging the fastening mechanism 52 to fasten the pivoting body 34 relative to the main body 32 and secure the latch rod 28 relative to the clip assembly 30. If the fastening mechanism 52 is configured as shown, the fastening mechanism 52 is moved into the fastening position by pressing the pivoting body 34 into the closed position until the snap 54 on the pivoting body 34 engages the detent 56 on the main body 32.

The method further includes inspecting the clip assembly 30 to ascertain the position of the pivoting body 34. The clip assembly 30 is inspected to determine if the pivoting body 34 has been successful fastened relative to the main body 32. When the pivoting body 34 has been successfully fastened to the main body 32, the pivoting body 34 is disposed in the closed position. When the pivoting body 34 has not been successfully fastened to the main body 32, the biasing force from the biasing device 58 urges the pivoting body 34 back into the open position. Accordingly, when the pivoting body 34 is disposed in the open position, an un-successful fastening of the pivoting body 34 relative to the main body 32 is indicated. Inspecting the clip assembly 30 to ascertain the position of the pivoting body 34 may further be defined as visually and/or functionally inspecting the clip assembly 30 to ascertain the position of the pivoting body 34. Accordingly, inspecting the clip assembly 30 may easily be performed by an assembler during assembly of the door assembly 20. If the pivoting body 34 fails to properly close, the biasing device 58 moves the pivoting body 34 back into the open position so that the assembler may quickly discern through visual inspection that the fastening mechanism 52 has failed to properly fasten the pivoting body 34 to the main body 32, and thereby that the latch rod 28 is not properly secured to the clip assembly 30. Alternatively, the assembler may quickly discern through a functional inspection or test, for example by failure of the door handle 24 to properly actuate the lath mechanism 26, that the fastening mechanism 52 has failed to properly fasten the pivoting body 34 to the main body 32, and thereby that the latch rod 28 is not properly secured to the clip assembly 30.

While the best modes for carrying out the invention have been described in detail, those familiar with the art to which this invention relates will recognize various alternative designs and embodiments for practicing the invention within the scope of the appended claims.

1. A clip assembly for securing a latch rod relative to a latch mechanism of a vehicle door panel, the clip assembly comprising:
a main body including an alignment feature configured for aligning the latch rod along an alignment axis relative to said main body;
a pivoting body rotatably coupled to said main body for rotational movement about a pivot axis, said pivoting body moveable between an open position for allowing insertion of the latch rod into said alignment feature and a closed position for securing the latch rod relative to said main body;
a fastening mechanism moveable between a fastened position securing said pivoting body in said closed position and an un-fastened position allowing said rotational movement of said pivoting body; and
a biasing device coupled to said main body and configured for biasing said pivoting body into said open position when said fastening mechanism is in said un-fastened position.

2. A clip assembly as set forth in claim 1 wherein said biasing device includes a spring.

3. A clip assembly as set forth in claim 2 wherein said spring includes a cantilevered leaf spring extending outward from said main body in a perpendicular relationship relative to said pivot axis for engaging said pivoting body.

4. A clip assembly as set forth in claim 3 wherein said pivoting body includes a peg extending outward from said pivoting body in parallel relationship relative to said pivot axis for engaging said cantilevered leaf spring during said rotational movement of said pivoting body relative to said main body.

5. A clip assembly as set forth in claim 1 wherein said alignment feature includes at least one pocket having a cross section defining a semi-circular shape presenting an open face perpendicular to said alignment axis.

6. A clip assembly as set forth in claim 5 wherein said at least one pocket includes a first pocket and a second pocket axially spaced from said first pocket along said alignment axis.

7. A clip assembly as set forth in claim 6 wherein said circular cross section of each of said first pocket and said second pocket define a diameter greater than an outer diameter of the latch rod to permit axial movement of the latch rod along said alignment axis when said fastening mechanism is in said un-fastened position.

8. A clip assembly as set forth in claim 1 wherein said fastening mechanism includes a snap extending from said pivoting body and configured for engaging a detent on said main body in interlocking engagement when in said fastened position.

9. A clip assembly as set forth in claim 1 wherein said alignment axis is parallel with and laterally spaced from said pivot axis.

10. A door assembly for a vehicle, the door assembly comprising:
a door panel supporting a door handle;
a latch mechanism;
a latch rod interconnecting said door handle and said locking mechanism and configured for transferring motion from said door handle to said latch mechanism; and
a clip assembly interconnecting said latch rod and said latch mechanism, the clip assembly including:
main body attached to said latch mechanism and including an alignment feature for aligning the latch rod along an alignment axis relative to said main body; wherein said alignment feature includes a first pocket and a second pocket axially spaced from said first pocket along said longitudinal axis, said first pocket and said second pocket each including a cross section defining a semi-circular shape presenting an open face perpendicular to said alignment axis for receiving said latch rod;
a pivoting body rotatably coupled to said main body for rotational movement about a pivot axis, said pivoting body moveable between an open position for allowing insertion of the latch rod into said alignment feature and a closed position for securing the latch rod relative to said alignment feature; wherein said pivot axis is parallel with and laterally offset from said alignment axis;
a fastening mechanism moveable between a fastened position securing said pivoting body in said closed position and an un-fastened position allowing said rotational movement of said pivoting body; and
a biasing device coupled to said main body and configured for biasing said pivoting body into said open position when said fastening mechanism is in said un-fastened position to provide a visual and functional indication that said fastening mechanism is not in said fastened position.

11. A door assembly as set forth in claim 10 wherein said biasing device includes a cantilevered leaf spring extending outward from said main body in a perpendicular relationship relative to said pivot axis for engaging said pivoting body.

12. A door assembly as set forth in claim 11 wherein said pivoting body includes a peg extending outward from said pivoting body in parallel relationship relative to said pivot axis for engaging said cantilevered leaf spring.

13. A door assembly as set forth in claim 10 wherein said fastening mechanism includes a snap extending from said pivoting body and configured for engaging a detent on said main body in interlocking engagement when in said fastened position.

14. A door assembly as set forth in claim 10 wherein said circular cross section of each of said first pocket and said second pocket define a diameter greater than an outer diameter of the latch rod to permit axial movement of the latch rod along said alignment axis when said fastening mechanism is in said un-fastened position.

15. A method of attaching a latch rod to a latch mechanism of a vehicle door panel with a clip assembly, the method comprising:
inserting the latch rod into an alignment feature of the clip assembly to position the latch rod relative to a main body of the clip assembly along an alignment axis;
rotating a pivoting body of the clip assembly relative to the main body about a pivot axis into engagement with a biasing device, which provides a biasing force to resist rotation of the pivoting body and to rotate the pivoting body against the biasing force into a closed position securing the latch rod relative to the main body;
engaging a fastening mechanism to fasten the pivoting body relative to the main body and secure the latch rod relative to the clip assembly; and
inspecting the clip assembly to ascertain the position of the pivoting body to determine successful fastening of the pivoting body relative to the main body, wherein the pivoting body is disposed in the closed position when the pivoting body is successfully fastened relative to the main body, and wherein the biasing force from the biasing device urges the pivoting body into an open position allowing movement of the latch rod relative to the main body to indicate an un-successful fastening of the pivoting body relative to the main body.

16. A method as set forth in claim 15 wherein inspecting the clip assembly to ascertain the position of the pivoting body is further defined as visually inspecting the clip assembly to ascertain the position of the pivoting body.

17. A method as set forth in claim 15 wherein the biasing device includes a leaf spring extending outward from the main body in perpendicular relationship relative to the alignment axis, and the pivoting body includes a peg extending outward from the pivoting body in parallel relationship relative to the alignment axis for engaging the leaf spring, wherein the method includes flexing the leaf spring with the peg during the rotation of the pivoting body relative to the main body to generate the biasing force for resisting the rotational movement of the pivoting body.

18. A method as set forth in claim 15 further comprising positioning the latch rod axially along the alignment axis relative to the clip assembly prior to engaging the fastening mechanism.

19. A method as set forth in claim 18 wherein the latch rod is freely moveable along the alignment axis within the alignment feature prior to engaging the fastening mechanism.

20. A method as set forth in claim 19 wherein the alignment feature includes at least one pocket having a cross section defining a semi-circular shape perpendicular to the alignment axis, and the method further includes sizing the semi-circular cross sectional shape of the at least one pocket to define an inner diameter greater than an outer diameter of the latch rod.
